(19) United States
(12) Patent Application Publication
(10) Pub. No.: US 2015/0072663 A1
(43) Pub. Date: Mar. 12, 2015

(54) Method and Apparatus for Providing Zone-Based Device Interaction

(71) Applicants: Suresh Chande, Espoo (FI); Sotiris Makrygiannis, Kuusamo (FI); Ahmad Qasim, Espoo (FI)

(72) Inventors: Suresh Chande, Espoo (FI); Sotiris Makrygiannis, Kuusamo (FI); Ahmad Qasim, Espoo (FI)

(21) Appl. No.: 14/233,834

(22) PCT Filed: Jul. 26, 2012
(86) PCT No.: PCT/FI2012/050753

§ 371 Date: Apr. 7, 2014

Related U.S. Application Data
(60) Provisional application No. 61/513,635, filed on Jul. 31, 2011.

(51) Int. Cl. H04W 4/02

(52) U.S. Cl. CPC H04W 4/02
USPC 455/414.1

(57) ABSTRACT

An approach is provided for zone-based device interaction. The approach involves causing, at least in part, an activation of at least one zone at a device. The at least one zone specifies, at least in part, user interaction configuration information. The approach also involves processing and/or facilitating a processing of the user interaction configuration information to select one or more applications, one or more services, application data, service data, or a combination thereof. The approach further involves causing, at least in part, a rendering of a user interface for presenting one or more representations of the one or more applications, the one or more services, the application data, the service data, or a combination.

### BACKGROUND

Service providers and device manufacturers (e.g., wireless, cellular, etc.) are continually challenged to deliver value and convenience to consumers by, for example, providing compelling network services and applications. As a result, the number of applications/services and their associated data have grown exponentially. For example, smartphone devices can be heavily populated with hundreds of applications and services available from catalogs or stores of hundreds of thousands or more choices. This vast library can make it difficult for end users to access applications of interest at any given context of the user, such as if the user is at home, at working, shopping, etc. Accordingly, service providers and device manufacturers face significant technical challenges to enabling efficient user interaction with applications and service depending on the user's specific context.

### SOME EXAMPLE EMBODIMENTS

Therefore, there is a need for an approach for customizing the end user experience and interaction with a device to the context or situation of use.

According to one embodiment, a method comprises causing, at least in part, an activation of at least one zone at a device. The at least one zone specifies, at least in part, user interaction configuration information. The method also comprises processing and/or facilitating a processing of the user interaction configuration information to select one or more applications, one or more services, application data, service data, or a combination thereof. The method further comprises causing, at least in part, a rendering of a user interface for presenting one or more representations of the one or more applications, the one or more services, the application data, the service data, or a combination.

According to another embodiment, an apparatus comprises at least one processor, and at least one memory including computer program code, the at least one memory and the computer program code configured to, with the at least one processor, cause, at least in part, an activation of at least one zone at a device. The at least one zone specifying, at least in part, user interaction configuration information. The apparatus is also caused to process and/or facilitate a processing of the user interaction configuration information to select one or more applications, one or more services, application data, service data, or a combination thereof. The apparatus further causes, at least in part, a rendering of a user interface for presenting one or more representations of the one or more applications, the one or more services, the application data, the service data, or a combination.

According to another embodiment, a computer-readable storage medium carries one or more sequences of one or more instructions which, when executed by one or more processors, cause, at least in part, an apparatus to activate at least one zone at a device. The at least one zone specifying, at least in part, user interaction configuration information. The apparatus is also caused to process and/or facilitate a processing of the user interaction configuration information to select one or more applications, one or more services, application data, service data, or a combination thereof. The apparatus further causes, at least in part, a rendering of a user interface for presenting one or more representations of the one or more applications, the one or more services, the application data, the service data, or a combination.

According to another embodiment, an apparatus comprises means for causing, at least in part, an activation of at least one zone at a device. The at least one zone specifying, at least in part, user interaction configuration information. The apparatus also comprises means for processing and/or facilitating a processing of the user interaction configuration information to select one or more applications, one or more services, application data, service data, or a combination thereof. The apparatus further comprises means for causing, at least in part, a rendering of a user interface for presenting one or more representations of the one or more applications, the one or more services, the application data, the service data, or a combination.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (including derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing zone-based device interaction, according to one embodiment;

FIG. 2 is a diagram of the components of a zone platform or zone application, according to one embodiment;

FIG. 3 is a diagram of the components of an advertising platform, according to one embodiment;

FIGS. 4A and 4B are flowcharts of processes for providing zone-based device interaction, according to various embodiments;

FIGS. 5A-5D are diagrams of user interfaces utilized in the processes of FIGS. 3, 4A, and 4B for providing zone-based device interaction, according to various embodiments;

FIGS. 6A and 6B are diagrams of user interfaces for defining a zone for device interaction, according to various embodiments;

FIGS. 7A and 7B are diagrams of processes for installing a zone platform, according to various embodiments;

FIG. 8 is a diagram of zone usage states, according to one embodiment;

FIG. 9 is a diagram of hardware that can be used to implement an embodiment of the invention;

FIG. 10 is a diagram of a chip set that can be used to implement an embodiment of the invention; and

FIG. 11 is a diagram of a mobile terminal (e.g., handset) that can be used to implement an embodiment of the invention.

### DESCRIPTION OF SOME EMBODIMENTS

Examples of a method, apparatus, and computer program for providing zone-based device interaction are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

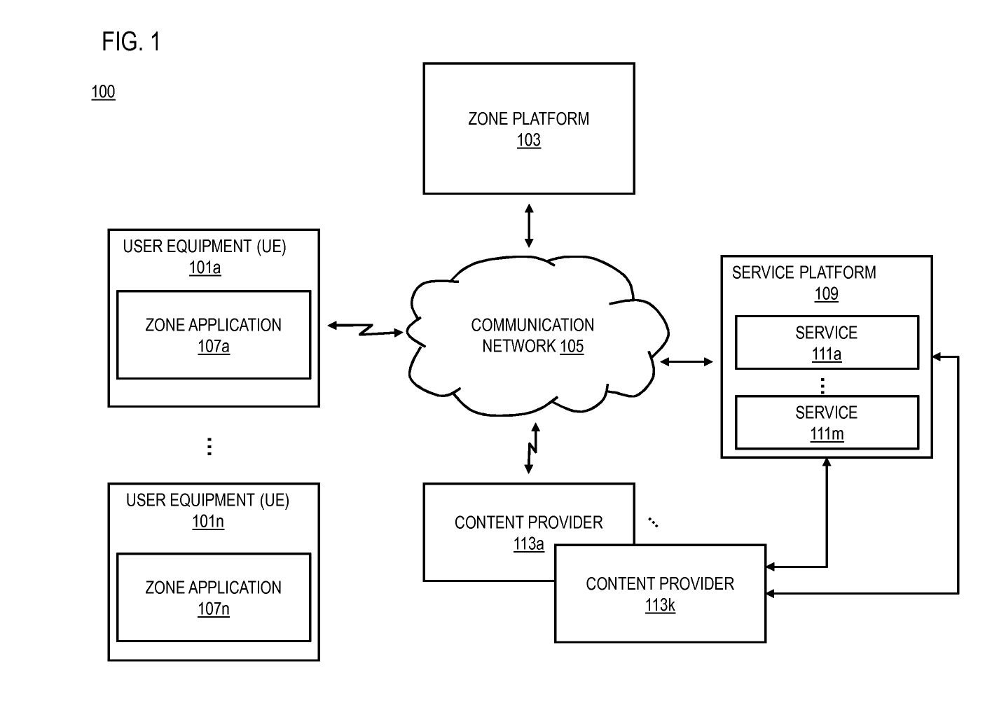

FIG. 1 is a diagram of a system capable of providing zone-based device interaction, according to one embodiment. As show in FIG. 1, a system 100 introduces the capability to provide a custom view or interaction with a device based, at least in part, on a determined zone (i.e., a context or situation) associated with the device. In one embodiment, a zone can be based on any contextual parameter or combination of parameters such as location, time, activity, participants, and the like. For example, a context or zone can be specified to customize device interaction for situations such as being at home, being at work, use of the device by children, being with family, shopping, etc. In another example, a zone contains role-based access to applications or services.

In one embodiment, a zone specifies user interaction configuration information for customizing the user interaction experience and/or user interface of a device. The customization, for instance, specifies or provides access to particular applications, services, and/or data that are relevant to a given zone or context. In other words, the system 100 can automatically present or package together a set of applications, services, and data to make use of the device more comfortable or convenient when operating in a specific context. In this way, the various embodiments of the approach described herein reduces the burden on the end user associated with manually discovering and activating applications that might be of more use in certain zones, contexts, or situations. In some embodiments, the user interaction configuration information also specifies the characteristics or types of the user interface that will be enabled at the device to present the applications, services, and/or data relevant to the zone. For example, the system 100 can configure the device to provide different interaction experiences using any combination of a graphical user interface, voice-based interactions, haptic or audio feedback, and the like. In another embodiment, the system 100 can also customize the device's configuration (e.g., settings related WiFi, built-in FM transmitter, Bluetooth, cellular data, connections to other devices, etc.).

In one embodiment, the custom view can be presented in specific portions of the device user interface or the over the entire user interface of the device. The system 100 can, for instance, customize the user experience of a lock screen of the device while leaving the remaining user interface (e.g., the home screen, menu launcher, etc.). In addition or alternatively, the system 100 can customize both the lock screen, home screen, and/or any other user interface of the device. Customizing the user interface includes, for instance: (1) processing the user interface configuration information to determine what application, service, and/or data to present; (2) rendering the a user interface to present the determined items; (3) selecting rendering characteristics (e.g., visual appearance, animations, type of user interface, etc.) as well as the modes of the user interface (e.g., selecting a graphical user interface, voice-based user interface, haptics interface, audio interface, text-to-speech, etc.); and the like.

In some embodiments, the system 100 can also adapt the rendering of the user interface of the zone and/or the items (e.g., applications, services, data, etc.) based on use information, popularity information, etc. of the items. Use information, for instance, can reflect the number of times that an item is used or otherwise accessed, and popularity information can reflect ratings, expressed interest, number of installations, etc. For example, the items presented in the zone user interface can adapt its size based, at least in part, on the number of times an item is used. It is contemplated that the use information or popularity information can be with respect to an individual user, a group of users, users within the selected zone, or a combination thereof. In one embodiment, the system 100 monitors use of the device by one or more end users to determine the use or popularity of applications, services, and/or data items (e.g., which contacts are most called in a given context). The monitoring can then be used to generate the user interaction configuration information for selecting items to present in a given contextual user interface. In some embodiments, the zones themselves can be derived from the monitoring by analyzing a user's most frequent contexts over a given period of time. It is contemplated that the monitoring may be determined individually for specific users or may be derived from a representative sample group of users. In another embodiment, the activation or switching of zones at a device can be performed automatically based on this monitoring and/or other available historical use information.

In another embodiment, the system 100 can provide zone-based user interfaces that can provide or recommend contextually relevant information or items other than applications, services, and/or data that have been installed or used at a user's device. For example, the system 100 can provide targeted advertising information appropriate to a contextual zone activated at a device. In this way, the system 100 can present advertising information that can potentially be reflective of user interest, thereby potentially increasing advertising response rates.

In another embodiment, the system 100 can provide for interaction across multiple devices with the same activated zone. In other words, the system 100 provides the ability to support connected or multi-user zones (e.g., a family group zone, a work group zone, etc.), whereby user interfaces, applications, services, data, etc. can be made available or synchronized across multiple devices. In some embodiments, the group or connected zones can specify which devices have access rights to the information (e.g., user interaction configuration information, device configuration information, applications, services, data, etc.) that are available within the connected zones. Moreover, zone owners or administrators (e.g., a group leader) can define the types of applications, services, and/or data that can be accessed by zone members. With these features, the system 100 can, for instance, define access policies, privacy policies, security policies, etc. for any of the devices or subset of devices within a zone. For example, a zone can be created specifically tailored to children. The children's zone can disable access or editing to certain data on the device (e.g., parents' contacts, calendar entries, etc.), and provide access to only those applications, services, and/or data that are suitable for children. In another embodiment, a zone (e.g., the children's zone) can operate in a “sandbox” mode, whereby data created within the zone is maintained separately from other device data or data created in other zones. For example, photos taken by a device while operating in the children's zone can be kept separate from other pictures of the device. In this way, a parent can activate the children's zone when lending the parent's device to a child to prevent commingling of data.

In yet another embodiment, the system 100 can define a zone as a local zone, whereby the zone is available only when a device is within a predetermined boundary or within a predetermined proximity of a location. By way of example, a point of interest (e.g., a store, restaurant, bar, etc.) can create a zone that provides a user experience that is available only to those devices physically located in a zone corresponding to the point of interest's location. For example, a bar can provide a user interface with an application that enables a device to order or play music over the bar's music system (e.g., a jukebox) only to devices that are actually in the bar.

As shown in FIG. 1, the system 100 comprises user equipment (UEs) 101a-101n (also collectively referred to as UEs 101) having connectivity to a zone platform 103 over a communication network 105. The UEs 101a also include, at least in part, respective zone applications 107a-107n (also collectively referred to as zone applications 107). In one embodiment, the zone platform 103 and the zone applications 107, individually or in combination, perform one or more processes for providing zone-based device interaction as described herein. By way of example, the items (e.g., applications, services, data, etc.) comprising the user interaction or experience associated with a contextual zone can be provided by the service platform 109, the services 111a-111m (also collectively referred to as services 111) within the service platform 109, and/or the content providers 113a-113k (also collectively referred to as content providers 113. For example, the service platform 109 and/or the service 111 may obtain data or content from the content providers 113 for delivery to the UEs 101 for processing by the zone platform 103 and/or the zone applications 107. Each of the services 111a-111m, for instance, may provide different content and/or different types of applications or services (e.g., a social networking service, a messaging service or a music service). It is also contemplated that the items may be provided or otherwise obtained locally at the respective UEs 101 (e.g., items previously installed at the UEs 101). The zone platform 103 and/or the zone applications 107 may then process the items to customize the user interactions supported under each contextual zone.

In one embodiment, the UEs 101 include or have connectivity to any number of sensors for determining contextual information (e.g., a location, a time, an activity, etc.) that can be processed to determine whether to activate a particular zone. The sensors include, for instance, location sensors (e.g., GPS, radio triangulation, etc.), magnetometers, accelerometers, gyroscopes, light meters, cameras, microphones, and the like. In addition or alternatively, contextual information can also be provided to the UEs 101 by the service platform 109 and/or the services 111 (e.g., location-based services, weather services, personal information management services, etc.). In this way, the UEs 101 need not include sensors, but instead may obtain relevant contextual information over the communication network 105.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UE 101, the zone platform 103, the zone applications 107, the service platform 109, the services 111, and the content providers 113 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

In one embodiment, the zone application 107 and the zone platform 103 may interact according to a client-server model. According to the client-server model, a client process sends a message including a request to a server process, and the server process responds by providing a service (e.g., providing map information). The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

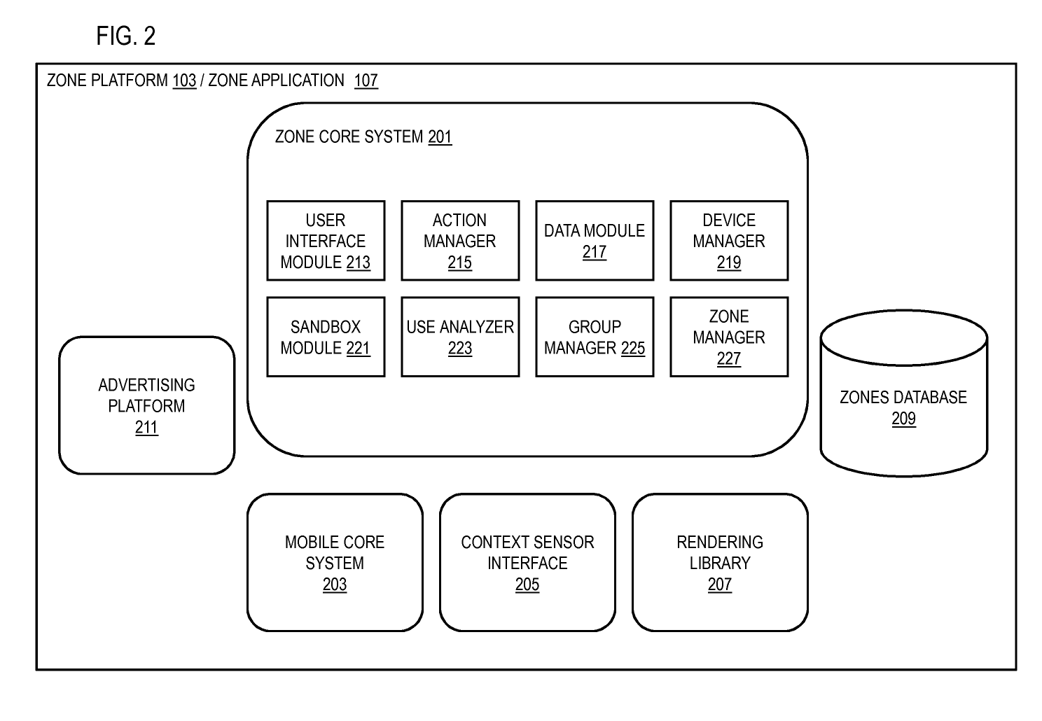

FIG. 2 is a diagram of the components of a zone platform or zone application, according to one embodiment. By way of example, the zone platform 103 and/or the zone application 107 include one or more components for providing zone-based device interaction. It is contemplated that the functions of these components may be combined in one or more components or performed by other components of equivalent functionality. In this embodiment, the zone platform 103 and/or the zone application 107 include (1) a zone core system 201 for providing modules and/or other functional components for customizing a user interface, user experience, user interactions, etc. based on one or more contexts or situations of the device; (2) a mobile core system 203 for providing functions for configuring a device (e.g., the UEs 101) to activate and present customized zones; (3) a context sensor interface 205 for interacting with one or more sensors for determining contextual information used by the zone platform 103 and/or zone application 107; (4) a user interface/experience rendering library 207 for customizing the rendering or presentation characteristics (e.g., the look and feel of the a graphical user interface; types of interactions—graphics, voice, audio; etc.) of zone items; (5) a zones database 209 for storing zone definitions, associated user interface configuration information (e.g., contextual criteria for activating a zone; relevant applications, services, and/or data; device configuration information; etc.); and (6) an advertising platform 211 or other source of third party items potentially relevant to a particular zone.

In one embodiment, the zone core system 201 includes several subcomponents including, for instance, a user interface module 213. The user interface module 213, for instance, specifies one or more plugins for customizing any portion of the device user interface (e.g., extensions for modifying the device lock screen or any other user interface screen). In addition the user interface module 213 may specify scripts or other code (e.g., expressed in Qt Modeling Language (QML)) for defining user interface elements for a particular zone. In one embodiment, the user interface module 213 can interact with the rendering library 207 for access to software objects to support specific routines or protocols for rendering the customize user interface.

The user interface module 213 can also interact with an action manager 215 that can translate interactions with the user interface elements associated with a zone into actions to be performed by the UE 101 or the applications, services, and/or data associated with zone. For example, if one user interface element corresponds to an application, the action manager 215 can initiate an execution of the application. Similarly, if the user interface element is associated with data, the action manager 215 can determine what application should operate on the data, and then initiates the execution of the application to process or use the data selected in the user interface. A data module 217 can interact with the action manager 215 to retrieve the data to process, provide notifications regarding the data or associated applications/services. In some embodiments, the data module 217 can also provide synchronization capabilities for the applications, services, and/or data. In other embodiments, the data module 217 interfaces with the content providers 113 obtain content or other media (e.g., icons, tones, wallpapers, audio, video, applications, etc.) for customizing a zone.

In one embodiment, a device manager 219 can then apply device configuration information (e.g., phone settings, connectivity settings, device connections, access points, etc.) that is specific to a particular zone. For example, on entering a zone, the device manager 219 can automatically provide credentials for accessing a private network. In another example, when operating in a car zone, the device manager 219 can determine that there is connectivity to a car Bluetooth device which can then, in turn, trigger activation of a car zone or interface. In some embodiments, the device manager 219 can interact with the sandbox module 221 to determine and/or apply access policies, privacy policies, security policies, and the like based, at least in part, on the selected zone. As described previously, the sandbox module 221 can support the segregation or compartmentalization of data on a device based on activation of different zones. In this way, data created, consumed, or otherwise used at a device can be maintained separately from data associated with another zone.

In one embodiment, the zone core system 201 includes a use analyzer 223 for tracking the usage of a specific zone with respect to one or more contexts or situations (e.g., a location, time, etc.). The use analyzer 223 can then store the tracking data as historical information in, for instance, the zones database 209. By way of example, tracked information includes, at least in part, WiFi access points, cell tower IDs, Bluetooth access points, applications/services used, data accessed, etc. In one embodiment, the historical information can be processed by the use analyzer 223 to predict what contexts or situations are associated with a user then automatically trigger the activation of a zone based, at least in part, on the prediction. By way of example, the use analyzer 223 predicts the potential zone that should be activated at a given period of time. In one embodiment, when the use analyzer 223 can predict the zone with a predetermined accuracy threshold (e.g., 95% accuracy), the use analyzer 223 can initiate activation of the predicted zone. In some embodiments, the zone can be activated automatically or after prompting the user for confirmation.

In another embodiment, the use analyzer 223 can also perform contextual zone information aggregation functions. For example, depending on the context of the user's situation, the use analyzer 223 can aggregate from over the cloud (e.g., from one or more services 111 over the communication network 105), relevant services, online web sites, people and events or interest, advertisements, etc. for presentation in a zone. In addition, the use analyzer 223 can generate statistics to show the most used zones, the most used zone items or functionalities, etc. This information can then be used to further customize the zones by generating user interface configuration information that is more reflective of actual use.

In one embodiment, the zone core system 201 includes a group manager 225 to support connected or group zones (e.g., a family connected to a zone). In this way, the group manager 225 can enable the group to share applications, services, and/or data customized in a particular zone. For example, all pictures placed in a connected or group zone can be made instantly available to all members of the group within the zone. The group manager 225 also provides that ability to specifically define the group of devices that should be connected in a group. In one embodiment, it is contemplated that the group manager 225 can use any authentication and/or security mechanism to ensure that only authorized members are able to participate and share items in a secured connected zone.

Finally, as shown, a zone manager 227 enables users, service providers, advertisers, merchants, etc. to define additional zones. In one embodiment, the zone core system 201 provides a set of default zones (e.g., office, car, home, shopping, silent, etc.) that can be activated. The zone manager 227 enables the editing of the default or the creation of new zones. By way of example, the zone manager 227 can provide a native application, a web portal, etc. for managing zones. Once created, the zones can be stored in the zones database 209 and then shared with other UEs 101 via a server, via peer-to-peer sharing, or other means for sharing such information.

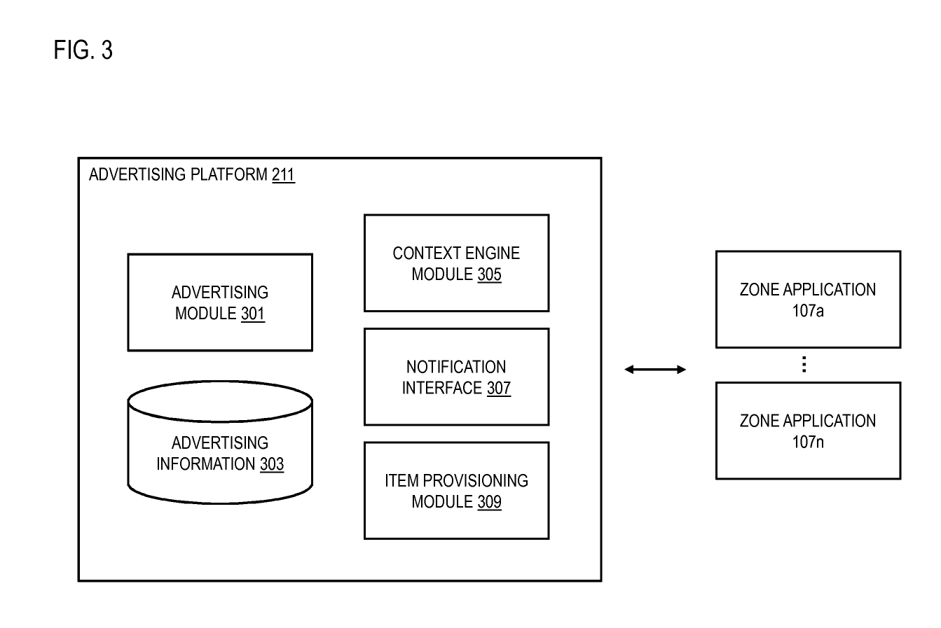

FIG. 3 is a diagram of the components of an advertising platform, according to one embodiment. By way of example, the advertising platform 211 includes one or more components for providing zone-based device interaction. It is contemplated that the functions of these components may be combined in one or more components or performed by other components of equivalent functionality. In this embodiment, the advertising platform 211 includes an advertising module 301, advertising information database 303, a context engine 305, a notification interface 307, and an item provisioning module 309 to determine advertising information relevant to a particular zone for transmission to the zone applications 107.

In one embodiment, the advertising module 301 interacts with the context engine 305 to aggregate context of the user. By way of example, the context engine 305 exposes interfaces to services that are used by the advertising module 301 to process the advertising information 303. In one embodiment, access to the context information is anonymized so advertising services cannot target a specific client (e.g., a specific zone application 107). Typically, only restricted profile data is made accessible (e.g., gender, age group, and device type). Additional contextual information collected include, for instance: (1) user status: actively using device/passive or dormant; (2) user zone: the zone that is currently activated at the user device; (3) location: geographic location of the user's device; (4) display mode: portrait/landscape; (5) advertising context: previous advertising information the user has consumed; and (6) zone context: historical data of which zone the user is expected to be during a particular date and/or time. Based on this information, the advertising module 301 can determine what portion of the advertising information 303 to present in a given zone.

In one embodiment, the advertising module can interact with the notification interface 307 to alert or to send the zone applications 107 the advertising. In some embodiments, the advertising platform 211 includes an item provisioning module 309 which includes, for instance, a set of interfaces for provisioning a zone via a cloud-based interface. The zone item is placed on the zone platform 103 based, at least in part, on: (1) display spot: location on the screen or user interface where the zone item (e.g., advertising item or information) can be visible; (2) zone: the zone in which the zone item should be visible such as in one zone or in all zones; (3) footprint: the time period when the zone item should be visible including, for instance, a number of view to the advertisement, size and highlighters for rendering, static/dynamic indicators, number of times the item can be used.

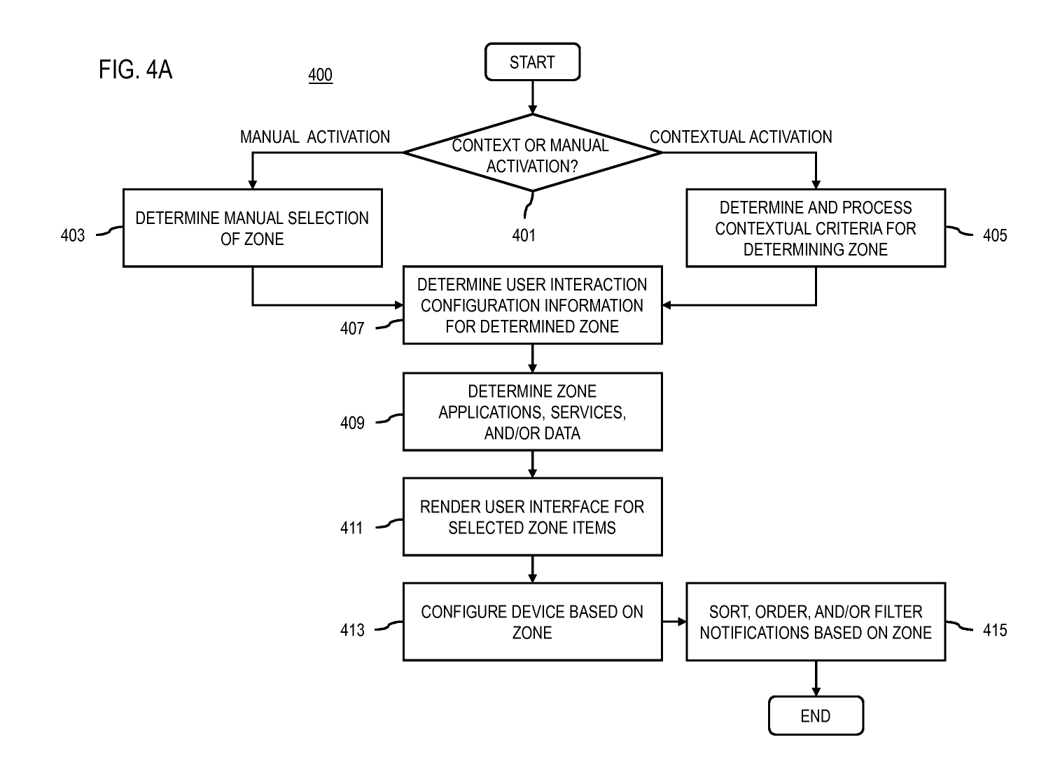

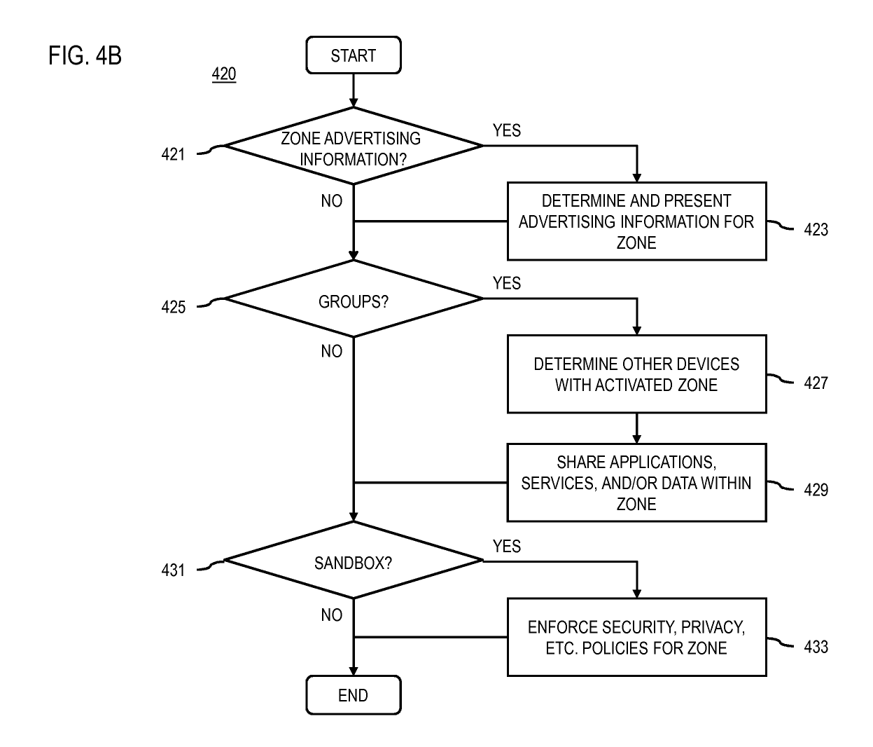

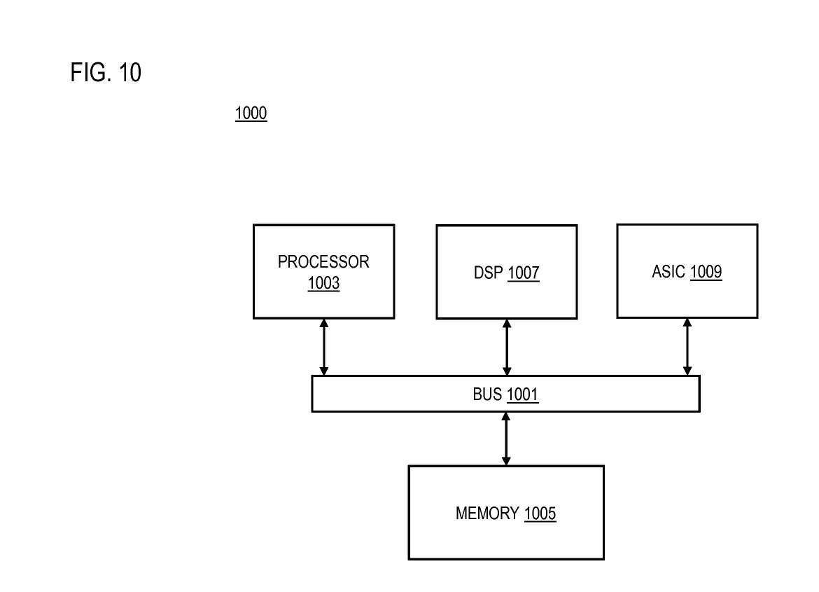

FIGS. 4A and 4B are flowcharts of processes for providing zone-based device interaction, according to various embodiments. In one embodiment, the zone platform 103 performs the process 400 of FIG. 4A and the process 420 of FIG. 4B, and is implemented in, for instance, a chip set including a processor and a memory as shown in FIG. 10. In addition or alternatively, the zone application 107 may perform all or a portion of the processes 400 and/or 420.

In step 401, the zone platform 103 determines whether the activation of a zone at a UE 101 is to be performed manually or by evaluating the UE 101's context information. If manual activation is to be performed, the zone platform 103 determines the manual selection of the zone by receiving an input from the user (step 403). If the activation of the zone by contextual activation, the zone platform 103 determines one or more contextual criteria associated with the at least one zone and processes and/or facilitates a processing of the contextual information associated with the device for comparison against the one or more contextual criteria (step 405). In some embodiments, the zone platform 103 causes, at least in part, a prediction of the contextual information based, at least in part, on historical contextual information associated with the device.

In step 407, the zone platform 103 causes, at least in part, an activation of at least one zone at a device, the at least one zone specifying, at least in part, user interaction configuration information. In one embodiment, the zone platform 103 determines one or more roles related to the at least one zone. The user interaction configuration information, the one or more applications, the one or more services, the application data, the service data, or a combination based, at least in part, on the one or more user roles are then determined based, at least in part, on the one or more roles. The zone platform 103 then process and/or facilitate a processing of the user interaction configuration information to select one or more applications, one or more services, application data, service data, or a combination thereof (step 409).

Next, the zone platform 103 causes, at least in part, a rendering of a user interface for presenting one or more representations of the one or more applications, the one or more services, the application data, the service data, or a combination (step 411). In one embodiment, the zone platform 103 determines use information, popularity information, or a combination thereof associated with the one or more applications, the one or more services, the application data, the service data, or a combination. The rendering of the one or more representations in the user interface is based, at least in part, the popularity information, or a combination with respect to the at least one zone.

In step 413, the zone platform 103 determines device configuration information associated with the at least one zone. The zone platform 103 then processes and/or facilitates a processing of the device configuration information to cause, at least in part, a configuration of the device on activation of the at least one zone. In one embodiment, the device configuration information includes, at least in part, connectivity configuration information, privacy configuration information, security configuration information, or a combination thereof.

In step 415, the zone platform 103 then causes, at least in part, a sorting, an ordering, a filtering, or a combination thereof of one or more device notification messages based, at least in part, on the at least one zone, the one or more applications, the one or more services, the application data, the service data, or a combination.

Continuing to the process 420 of FIG. 4B, the zone platform 103 determines whether there is any advertising information that is to be presented in the at least one zone (step 421). If yes, the zone platform 103 determines advertising information associated with the at least one zone (step 423). The zone platform 103 then causes, at least in part, a presentation of the advertising information in the user interface.

If no zone advertising information is to be presented, the zone platform 103 determines whether the at least one zone is a connected or group zone (step 425). If yes, the zone platform 103 determines one or more devices that have activated the at least one zone (step 427). The zone platform 103 then causes, at least in part, a sharing of the one or more applications, the one or more services, the application data, the service data, or a combination between the device and the one or more devices (step 429).

Next, the zone platform 103 determines whether the at least one zone should be activated with a sandbox policy (step 431). If yes, the zone platform 103 determines one or more security policies, one or more privacy policies, one or more access policies, etc. for segregating or compartmentalizing the zone data and causes, at least in part, an enforcement of the policies (step 433).

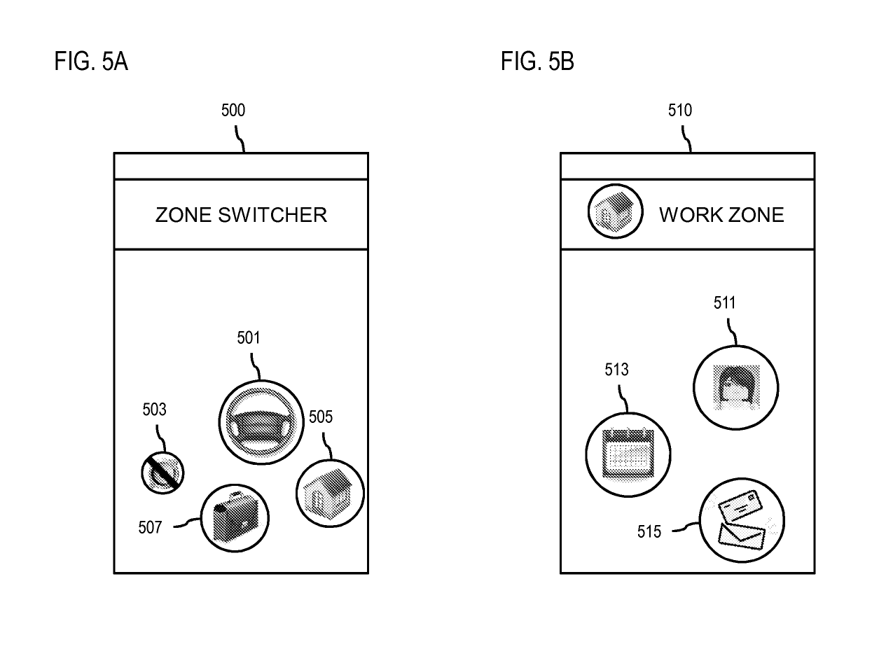

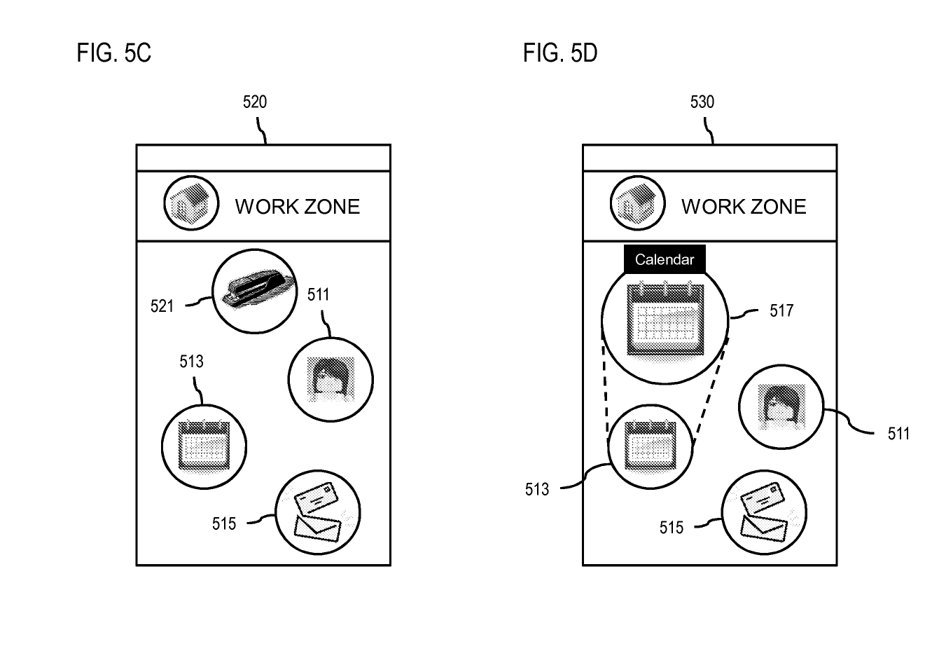

FIGS. 5A-5D are diagrams of user interfaces utilized in the processes of FIGS. 3, 4A, and 4B for providing zone-based device interaction, according to various embodiments. The user interfaces of FIGS. 5A-5D illustrate providing a customized zone user interface in a lock screen of a UE 101. As shown in FIG. 5A a user interface (UI) 500 depicts a lock screen with a customized zone user interface. More specifically, the UI 500 depicts a UI for manually selecting or switching zones. In the example of UI 500, icons 501-507 respectively represent different zones that can be activated at a UE 101. In this example, zone 501 is a car zone, zone 503 is a silent zone, zone 505 is a home zone, and zone 507 is a work zone. As shown, the zone platform 103 has rendered the zones 501-507 in different sizes to reflect their use or popularity information. The zone platform 103, for instances, renders the size of a zone based on the number of times the zone has been used. In this case, the zone 501 has been most often used and is rendered in the largest size. Zone 503 is least used, and is rendered in the smallest size. Zones 505 and 507 are roughly equally used, but with less frequency that zone 501 and more frequency than zone 503. Accordingly, zones 505 and 507 are rendered in medium size.

FIG. 5B depicts a UI 510 in which the work zone 507 has been activated. As shown, the UI depicts one or more representations (e.g., icons) representing applications, services, and/or data customized for the work zone 507. In this way, the user can easily discover items that are most relevant to the work zone 507. In the UI 501, the zone platform 103 has rendered a work contact 511, a work calendar application 513, and a work email application 515. Although the icons or representations of the items 511-515 are shown as equal size, the zone platform 103 can also vary the sizes of the items 511-515 to reflect use or popularity information as described with respect to the UI 500.

FIG. 5C depicts the work zone 507 as shown in the UI 510 of FIG. 5B with the addition of advertising information relevant to the work zone 507. In this example, the UI 520 includes an advertising item 521 (e.g., an advertisement for an office supply store) that the zone platform 103 predicts is of relevance to the user while the work zone 507 is activated. The user can then select the advertisement item 521 to launch a web page or initiate an order with the office supply store.

FIG. 5D depicts the work zone 507 as shown in the UE 510 of FIG. 5B and further illustrates the process of dynamically sizing and annotating a zone item based on a user selection. In this example, the user selects application item 513 from among the items 511-515. On making the selection, the zone platform 103 re-renders the application item 513 as item 517 in which the size of the rendering is increased and the name of the application “Calendar” is annotated in the item 517. In this way, the zone user interface 530 reacts to the user's selection by increasing the prominence and/or visibility of the selected item 513.

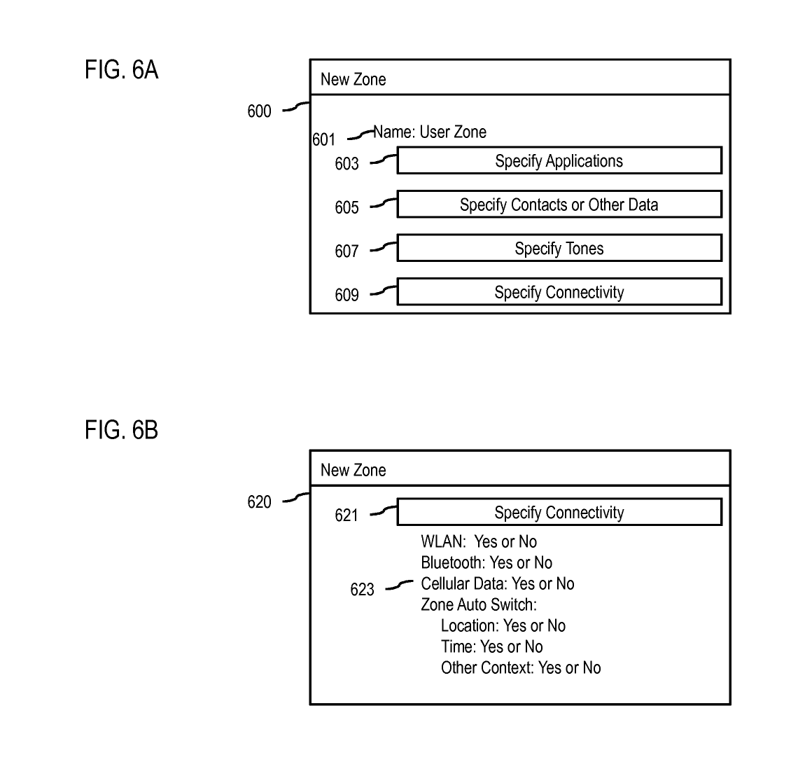

FIGS. 6A and 6B are diagrams of user interfaces for defining a zone for device interaction, according to various embodiments. As shown in FIG. 6A, a UI 600 illustrates a new zone entry screen that includes a zone name input field 601, an option 603 to specify relevant applications, an option 605 to specify relevant contacts or other data, an option 607 to specify alert tones, an option 609 to specify connectivity configuration information. In this example, the user selects option 609 and is presented with the UI 620 of FIG. 6B. The UI 620 provides an input screen 621 for specifying wireless connectivity options for when the new zone is activated. The user is able to select whether to turn on, for instance, the WLAN, Bluetooth, and cellular data 623. In addition, the user can specify whether the zone can be automatically activated as well as the contextual criteria for the automatic activation.

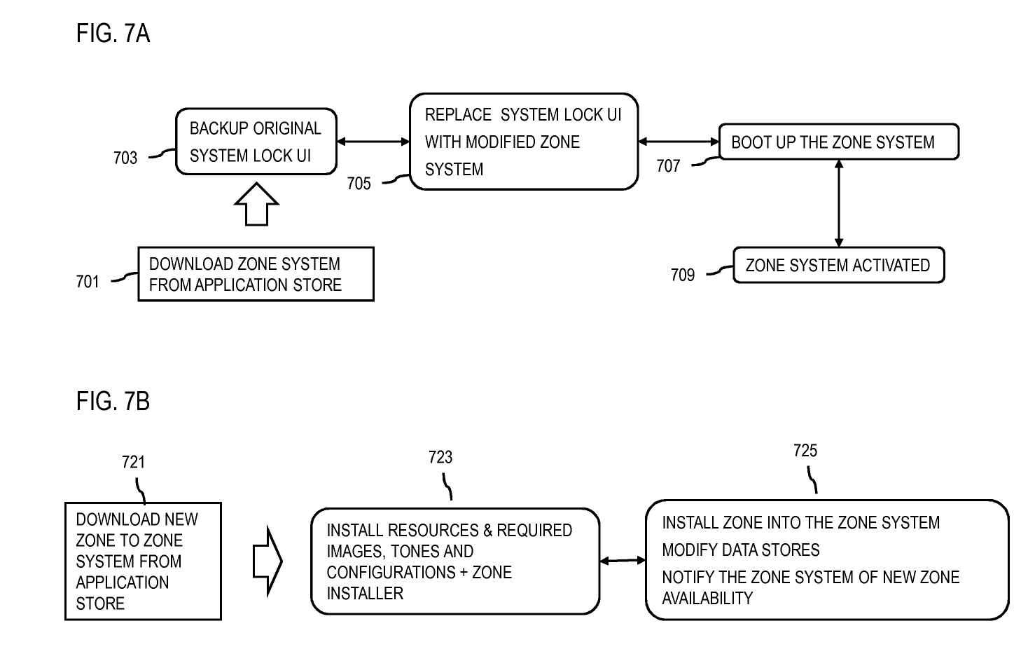

FIGS. 7A and 7B are diagrams of processes for installing a zone platform, according to various embodiments. FIG. 7A depicts a process for downloading and installing the zone core system 201 to a UE 101. In step 701, the UE 101 downloads the zone system 201 from, for instance, an application store. It is contemplated that the zone system 201 may be downloaded from any other available source or, alternatively, be preloaded on the device. In this example, the zone system 201 acts via the lock screen user interface of the UE 101. Accordingly, in step 703, a backup of the original system lock screen user interface is backed up in the event the user would like to uninstall the zone system 201. Following the backup, the original lock screen user interface is replaced with the zone system 201 lock screen (step 705). The UE 101 is booted with the new zone system 201 installed (step 707) and the zone system 201 is activated to begin monitoring contextual information and/or receiving input for determining when and which zones to activate on the UE 101 (step 709).

FIG. 7B depicts a process for downloading a new zone to a UE 101 that has previously installed the zone system 201. In step 721, a new zone is downloaded to the zone system 201 from the application store. The newly downloaded zone and support files (e.g., resources, images, tones, user interface configuration information, device configuration information, installer files, etc.) are installed to the UE 101 (step 723). The new zone and files are then installed to the zone system 201 (step 725). In one embodiment, installation includes modifying data stores (e.g., to update resource or support files) and then notifying the zone system 201 of the availability of a new zone.

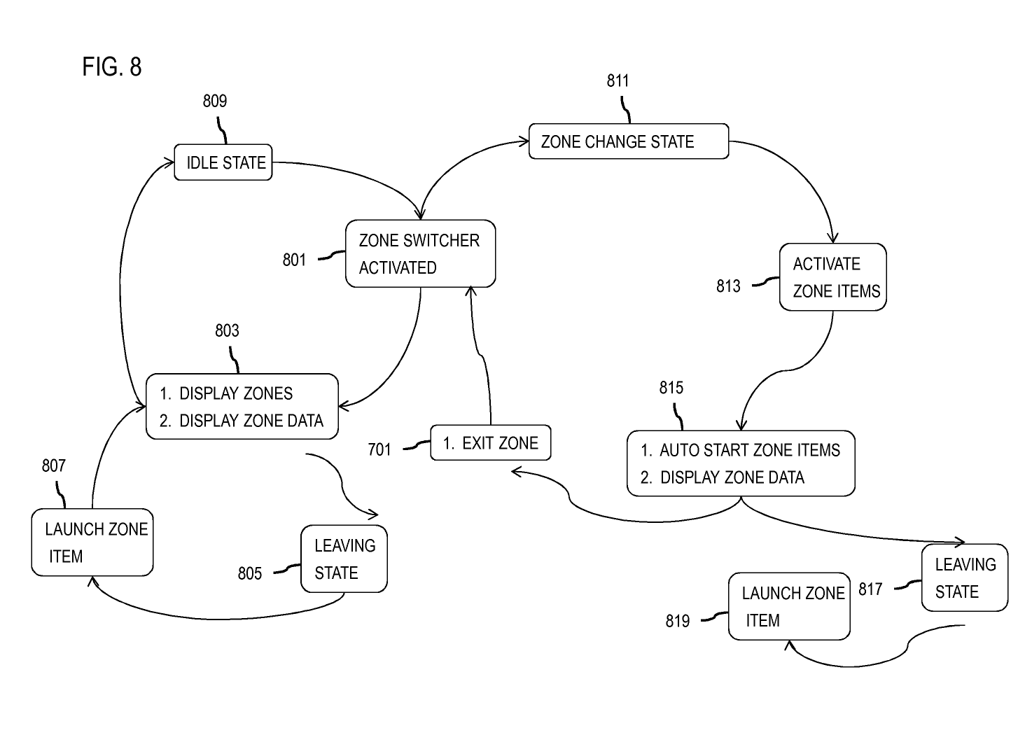

FIG. 8 is a diagram of zone usage states, according to one embodiment. At state 801, the zone platform 103 activates the zone switcher. In other words, a user interface presenting available zones and their associated data is presented (state 803). If the zone platform 103 detects a user interaction at from the zone display of state 803, the zone platform leaves the state (at 805) and launches the selected zone item (state 807). If no selection is made at the display state 803, the zone platform 103 continues with an idle state 809.

Returning the zone switcher state 801, if the user indicates an interaction to change the zone state (e.g., change or activate a new zone), the zone platform 103 enters a zone change state 811 and then activates the zone items associated with the newly selected state (at 813). The zone platform 103 then initializes the new zone by auto starting any preconfigured zone items (e.g., autostarting device connectivity options) and display the items associated with the new zone (at 815). On detecting an interaction to launch one or more of the zone items, the zone platform 103 leaves the new zone display state (at 817) and proceeds to enter a state for launching the selected zone item (state 819).

The processes described herein for providing zone-based device interaction may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

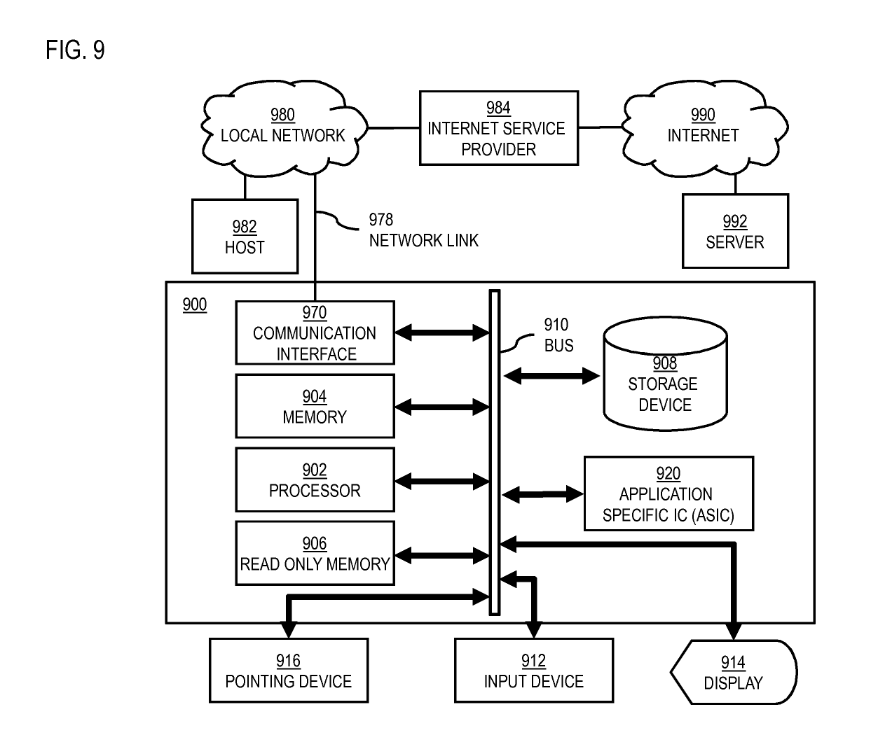

FIG. 9 illustrates a computer system 900 upon which an embodiment of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to provide zone-based device interaction as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of providing zone-based device interaction.

A bus 910 includes one or more parallel conductors of information so that information is transferred quickly among devices coupled to the bus 910. One or more processors 902 for processing information are coupled with the bus 910.

A processor (or multiple processors) 902 performs a set of operations on information as specified by computer program code related to providing zone-based device interaction. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or any other dynamic storage device, stores information including processor instructions for providing zone-based device interaction. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or any other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for providing zone-based device interaction, is provided to the bus 910 for use by the processor from an external input device 912, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT), a liquid crystal display (LCD), a light emitting diode (LED) display, an organic LED (OLED) display, a plasma screen, or a printer for presenting text or images, and a pointing device 916, such as a mouse, a trackball, cursor direction keys, or a motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of ASICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 105 for providing zone-based device interaction to the UE 101.

The term “computer-readable medium” as used herein refers to any medium that participates in providing information to processor 902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or any other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set or chip 1000 upon which an embodiment of the invention may be implemented. Chip set 1000 is programmed to providing zone-based device interaction as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1000 can be implemented in a single chip. It is further contemplated that in certain embodiments the chip set or chip 1000 can be implemented as a single “system on a chip.” It is further contemplated that in certain embodiments a separate ASIC would not be used, for example, and that all relevant functions as disclosed herein would be performed by a processor or processors. Chip set or chip 1000, or a portion thereof, constitutes a means for performing one or more steps of providing user interface navigation information associated with the availability of functions. Chip set or chip 1000, or a portion thereof, constitutes a means for performing one or more steps of providing zone-based device interaction.

In one embodiment, the chip set or chip 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1000 includes merely one or more processors and some software and/or firmware supporting and/or relating to and/or for the one or more processors.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to provide zone-based device interaction. The memory 1005 also stores the data associated with or generated by the execution of the inventive steps.

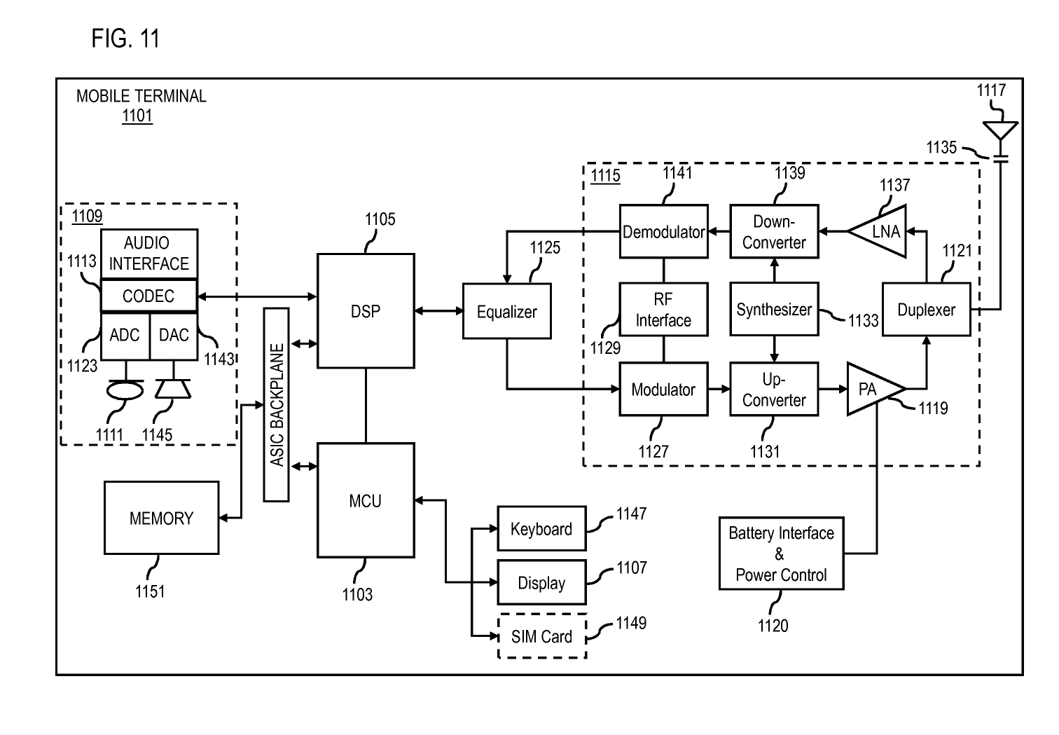

FIG. 11 is a diagram of exemplary components of a mobile terminal (e.g., handset) for communications, which is capable of operating in the system of FIG. 1, according to one embodiment. In some embodiments, mobile terminal 1101, or a portion thereof, constitutes a means for performing one or more steps of providing zone-based device interaction. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of providing zone-based device interaction. The display 1107 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103 which can be implemented as a Central Processing Unit (CPU).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to provide zone-based device interaction. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1-48. (canceled)

49. A method comprising:
causing, at least in part, an activation of at least one zone at a device, the at least one zone specifying, at least in part, user interaction configuration information;
processing and/or facilitating a processing of the user interaction configuration information to select one or more applications, one or more services, application data, service data, or a combination thereof; and
causing, at least in part, a rendering of a user interface for presenting one or more representations of the one or more applications, the one or more services, the application data, the service data, or a combination.

50. A method of claim 49, further comprising:
determining one or more contextual criteria associated with the at least one zone; and
processing and/or facilitating a processing of contextual information associated with the device for a comparison against the one or more contextual criteria,
wherein the activation of the at least one zone is based, at least in part, on the comparison.

51. A method of claim 50, further comprising:
causing, at least in part, a prediction of the contextual information based, at least in part, on historical contextual information associated with the device.

52. A method of claim 49, further comprising:
determining device configuration information associated with the at least one zone; and
processing and/or facilitating a processing of the device configuration information to cause, at least in part, a configuration of the device on activation of the at least one zone.

53. A method of claim 52, wherein the device configuration information includes, at least in part, connectivity configuration information, privacy configuration information, security configuration information, or a combination thereof.

54. A method of claim 49, further comprising:
determining use information, popularity information, or a combination thereof associated with the one or more applications, the one or more services, the application data, the service data, or a combination,
wherein the rendering of the one or more representations in the user interface is based, at least in part, the popularity information, or a combination with respect to the at least one zone.

55. A method of claim 49, further comprising:
determining one or more user roles related to the at least one zone; and
determining the user interaction configuration information, the one or more applications, the one or more services, the application data, the service data, or a combination based, at least in part, on the one or more user roles.

56. A method of claim 49, further comprising:
determining advertising information associated with the at least one zone; and
causing, at least in part, a presentation of the advertising information in the user interface.

57. A method of claim 49, further comprising:
determining one or more devices that have activated the at least one zone; and
causing, at least in part, a sharing of the one or more applications, the one or more services, the application data, the service data, or a combination between the device and the one or more devices.

58. A method of claim 49, further comprising:
causing, at least in part, a sorting, an ordering, a filtering, or a combination thereof of one or more device notification messages based, at least in part, on the at least one zone, the one or more applications, the one or more services, the application data, the service data, or a combination.

59. A method of claim 49, wherein the activation of the at least one zone is caused, at least in part, to be performed manually by receiving an input.

60. A method of claim 49, further comprising:
supporting a zone operating in a mode where data created, consumed or otherwise used at the device is maintained separately from data associated with another zone.

61. An apparatus comprising:
at least one processor; and
at least one memory including computer program code for one or more programs,
the at least one memory and the computer program code configured to, with the at least one processor, cause the apparatus to perform at least the following,
cause, at least in part, an activation of at least one zone at a device, the at least one zone specifying, at least in part, user interaction configuration information;
process and/or facilitate a processing of the user interaction configuration information to select one or more applications, one or more services, application data, service data, or a combination thereof; and
cause, at least in part, a rendering of a user interface for presenting one or more representations of the one or more applications, the one or more services, the application data, the service data, or a combination.

62. An apparatus of claim 61, wherein the apparatus is further caused to:
determine one or more contextual criteria associated with the at least one zone; and
process and/or facilitate a processing of contextual information associated with the device for a comparison against the one or more contextual criteria,
wherein the activation of the at least one zone is based, at least in part, on the comparison.

63. An apparatus of claim 62, wherein the apparatus is further caused to:
cause, at least in part, a prediction of the contextual information based, at least in part, on historical contextual information associated with the device.

64. An apparatus of claim 61, wherein the apparatus is further caused to:
determine device configuration information associated with the at least one zone; and
process and/or facilitate a processing of the device configuration information to cause, at least in part, a configuration of the device on activation of the at least one zone.

65. An apparatus of claim 64, wherein the device configuration information includes, at least in part, connectivity configuration information, privacy configuration information, security configuration information, or a combination thereof.

66. An apparatus of claim 61, wherein the apparatus is further caused to:
determine use information, popularity information, or a combination thereof associated with the one or more applications, the one or more services, the application data, the service data, or a combination,
wherein the rendering of the one or more representations in the user interface is based, at least in part, the popularity information, or a combination with respect to the at least one zone.

67. An apparatus of claim 61, wherein the apparatus is further caused to:
determine one or more user roles related to the at least one zone; and
determine the user interaction configuration information, the one or more applications, the one or more services, the application data, the service data, or a combination based, at least in part, on the one or more user roles.

68. An apparatus of claim 61, wherein the apparatus is further caused to:
determine advertising information associated with the at least one zone; and
cause, at least in part, a presentation of the advertising information in the user interface.

69. An apparatus of claim 61, wherein the apparatus is further caused to:
determine one or more devices that have activated the at least one zone; and
cause, at least in part, a sharing of the one or more applications, the one or more services, the application data, the service data, or a combination between the device and the one or more devices.

70. An apparatus of claim 61, wherein the apparatus is further caused to:
cause, at least in part, a sorting, an ordering, a filtering, or a combination thereof of one or more device notification messages based, at least in part, on the at least one zone, the one or more applications, the one or more services, the application data, the service data, or a combination.
